(19) United States
(12) Patent Application Publication
(10) Pub. No.: US 2016/0042295 A1
(43) Pub. Date: Feb. 11, 2016

(54) SUPPORT VECTOR MACHINE COMPUTATION

(71) Applicant: International Business Machines Corporation, Armonk, NY (US)

(72) Inventor: Nimrod Megiddo, Palo Alto, CA (US)

(21) Appl. No.: 14/454,020

(22) Filed: Aug. 7, 2014

(51) Int. Cl. G06N 99/00; G06F 17/10

(52) U.S. Cl. CPC G06N 99/005; G06F 17/10

(57) ABSTRACT

A technique solves an SVM problem on table J, defined as the join of two tables T₁ and T₂, without explicitly joining the tables T₁ and T₂, in which the table T₁ has m rows (pᵢ^{T}, uᵢ^{T}), i=1, . . . , m, and the table T₂ has n rows (qⱼ^{T}, vⱼ^{T}), j=1, . . . , n. A computer obtains a modified optimization problem from a primal optimization problem in which the modified optimization problem includes minimize_{w,b,η,ζ}½∥w∥²+C·Σᵢ₌₁^{m}J(i)·ηᵢ+C·Σⱼ₌₁ⁿI(j)·ζⱼ, subject to yᵢxᵢⱼ^{T}w−yᵢb+ηᵢ+ζⱼ≧1 ((i,j)∈IJ) and ηᵢ, ζⱼ≧0. The penalty variables are reduced in the modified optimization problem by replacing the penalty variables in a form of ξᵢⱼ for each (i,j)∈IJ with the penalty variables in a form of ζᵢⱼ=ηᵢ+ζⱼ. A compact form of the modified optimization problem is obtained which includes minimize_{w,b,η,ζ,σ,τ}½∥w_{P}∥²+½∥w_{U}∥²+½∥w_{Q}∥²+C·Σᵢ₌₁^{m}J(i)·ηᵢ+C·Σⱼ₌₁ⁿI(j) ·ζⱼ which is subject to yᵢpᵢ^{T}w_{P}−yᵢb+ξᵢ−σₖ≧0 (i∈Iₖ, k=1, . . . l), qⱼ^{T}w_{Q}−τₖ≧0 (j∈Jₖ, k=1, . . . l), σₖ+zₖ^{T}w_{U}+τₖ≧1 (for k=1, . . . l such that Jₖ≠), σₖzₖ^{T}w_{U}≧1 (for k=1, . . . l such that Jₖ=), and ξᵢ≧0 (i=1, . . . , m). The compact form of the modified optimization problem is solved.

### BACKGROUND

The present invention relates to support vector machines, and more specifically, to optimize the computations for support vector machines.

In machine learning, support vector machines (SVMs, also support vector networks) are supervised learning models with associated learning algorithms that analyze data and recognize patterns, used for classification and regression analysis. Given a set of training examples, each marked as belonging to one of two categories, an SVM training algorithm builds a model that assigns new examples into one category or the other, making it a deterministic binary linear classifier. An SVM model is a representation of the examples as points in space, mapped so that the examples of the separate categories are divided by a clear gap that is as wide as possible, yet allowing some points to lie on the opposite side and penalized for that. New examples are then mapped into that same space and predicted to belong to a category based on which side of the gap they fall on.

### SUMMARY

According to one embodiment, a method, by a computer, of solving a support vector machine problem on table J, defined as the join of two tables T₁ and T₂, without explicitly joining the tables T₁ and T₂ is provided, in which the table T₁ has m rows (pᵢ^{T}, uᵢ^{T}), i=1, . . . , m, and the table T₂ has n rows (qⱼ^{T}, vⱼ^{T}), j=1, . . . , n. The method includes providing a primal optimization problem over a join of the tables T₁ and T₂ and obtaining a modified optimization problem from the primal optimization problem. The computer reduces penalty variables in the modified optimization problem by replacing the penalty variables in a form of ξᵢⱼ for each (i,j)∈IJ with the penalty variables in a form of ξᵢⱼ=ηᵢ+ζⱼ. The computer obtains a compact form of the modified optimization problem in which the compact form comprises the penalty variables in the form of ξᵢⱼ=ηᵢ+ζⱼ. The computer solves the compact form of the modified optimization problem.

Additional features and advantages are realized through the techniques of the embodiments of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a computer for executing support vector machines according to an embodiment.

FIG. 2 illustrates one example a computer program product according to an embodiment.

FIG. 3 illustrates a method, executed by one or more processors on the computer, of solving a support vector machine problem according to an embodiment.

### DETAILED DESCRIPTION

The support vector machines (SVM) have become a very important tool for the classification problem. Computing an SVM amounts to solving a certain optimization problem. The SVM optimization problem is posed with respect to a set of labeled examples given explicitly. In real-life databases, the data is often distributed over various tables. Even if the data is given in a single table, there are often external sources of data that can improve the accuracy of a classifier if incorporated in the classifier. For example, a given table providing attributes of individuals that have to be classified may include the town where the individual resides but no attributes of that town. An external source may provide various attributes of towns or transactions that took place in various towns, which may be relevant to the classification of individuals. Thus, it is desirable to build a classifier that takes some of these attributes or transactions into account. This hypothesis calls for joining the tables on the town column.

To apply a standard SVM algorithm when attributes are distributed over tables, one has to first to join the tables. However, joining tables explicitly may not be possible due to the size of the product. Thus, the question is whether it is possible to obtain an SVM for the join without generating the table explicitly. Here, it is shown how this can be done for the join of two tables. In general, the size of the join of two tables can be quadratic in the terms of the sizes of the joined tables. Embodiments are configured to modify standard SVM problems as discussed further below (in algorithms).

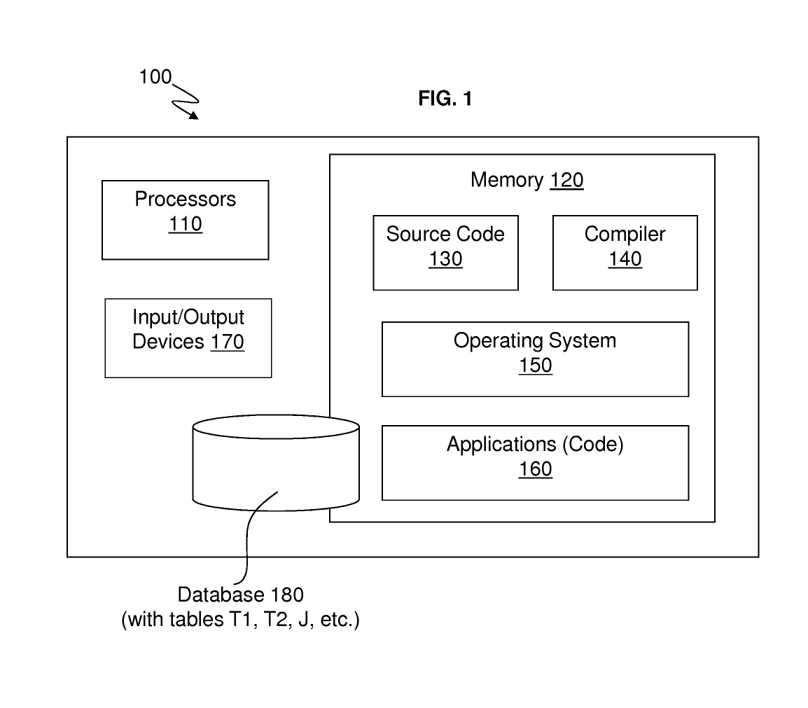

Turning to the figures, FIG. 1 illustrates an example computer 100 (e.g., any type of computer system such as a server) that may implement features such as support vector machines, discussed herein. The computer 100 may be a distributed computer system over more than one computer. Various methods, procedures, modules, flow diagrams, tools, applications, circuits, elements, and techniques discussed herein may also incorporate and/or utilize the capabilities of the computer 100. Indeed, capabilities of the computer 100 may be utilized to implement and execute features of exemplary embodiments discussed herein.

Generally, in terms of hardware architecture, the computer 100 may include one or more processors 110, computer readable storage memory 120, and one or more input and/or output (I/O) devices 170 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 110 is a hardware device for executing software that can be stored in the memory 120. The processor 1510 can be virtually any custom made or commercially available processor, a central processing unit (CPU), a data signal processor (DSP), or an auxiliary processor among several processors associated with the computer 100, and the processor 110 may be a semiconductor based microprocessor (in the form of a microchip) or a macroprocessor.

The computer readable memory 1520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Note that the memory 120 can have a distributed architecture, where various components are situated remote from one another, but can be accessed by the processor(s) 110.

The software in the computer readable memory 120 may include one or more separate programs, each of which comprises an ordered listing of executable instructions for implementing logical functions. The software in the memory 120 includes a suitable operating system (O/S) 150, compiler 140, source code 130, and one or more applications 160 of the exemplary embodiments. As illustrated, the application 160 comprises numerous functional components for implementing the features, processes, methods, functions, and operations of the exemplary embodiments.

The operating system 150 may control the execution of other computer programs, and provides scheduling, input-output control, file and data management, memory management, and communication control and related services.

The software application 160 may be a source program, executable program (object code), script, or any other entity comprising a set of instructions to be performed. When a source program, then the program is usually translated via a compiler (such as the compiler 140), assembler, interpreter, or the like, which may or may not be included within the memory 120, so as to operate properly in connection with the O/S 1550. Furthermore, the application 160 can be written as (a) an object oriented programming language, which has classes of data and methods, or (b) a procedure programming language, which has routines, subroutines, and/or functions.

The I/O devices 170 may include input devices (or peripherals) such as, for example but not limited to, a mouse, keyboard, scanner, microphone, camera, etc. Furthermore, the I/O devices 150 may also include output devices (or peripherals), for example but not limited to, a printer, display, etc. Finally, the I/O devices 170 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 170 also include components for communicating over various networks, such as the Internet or an intranet. The I/O devices 170 may be connected to and/or communicate with the processor 110 utilizing Bluetooth connections and cables (via, e.g., Universal Serial Bus (USB) ports, serial ports, parallel ports, Fire Wire, HDMI (High-Definition Multimedia Interface), etc.).

Additionally, the computer 100 may include a database 180 stored in memory 120. The database 180 may include various tables such as table T₁ and T₂ discussed herein. Also, new table J may be stored in the database 180.

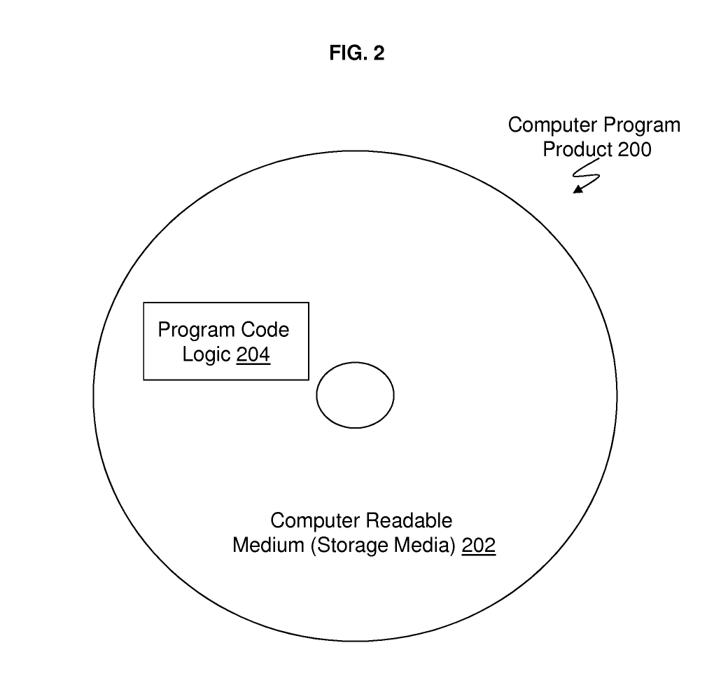

Referring now to FIG. 2, in one example, a computer program product 200 includes, for instance, one or more storage media 102, wherein the media may be tangible and/or non-transitory, to store computer readable program code means or logic 104 thereon to provide and facilitate one or more aspects of embodiments described herein.

Subsection headings are provided below for explanation purposes and for ease of understanding. The sub-section headings are not meant to limit the scope of the present disclosure. According to embodiments, the software application 160 running on the processor 110 of computer 100 is configured to execute each of the algorithms (including equations and problems) discussed herein (including the subsections below).

1. Standard SVM

We first review the standard SVM problem. The input table consists of m “examples” given as feature vectors xᵢ∈ [symbol] ^{d} and corresponding class labels yᵢ∈{−1, 1}, i=1, . . . , m.

The Primal Problem

The primal SVM optimization problem is the following:

Minimize_{w,b,ξ}½∥w∥²+C·Σᵢ₌₁^{m}ξᵢ subject to yᵢxᵢ^{T}w−yᵢb+ξᵢ≧1(i=1, . . . , m)ξᵢ≧0(i=1, . . . , m). (1)

Note that w is the unknown vector defining the orientation of a hyperplane, b is a scalar, and ξ is a vector of penalty variables.

The Dual Problem

The Lagrangian function of the problem in (1) is the following:

$$\begin{matrix}L ( w , b , ξ ; α ) = \frac{1}{2} {‖ w ‖}^{2} + C \cdot {\sum }_{i = 1}^{m} {ξ}_{i} - \\ {\sum }_{i = 1}^{m} {α}_{i} ( {y}_{i} {x}_{i}^{⊤} w - {y}_{i} b + {ξ}_{i} - 1 ) \\ = \frac{1}{2} {‖ w ‖}^{2} - {\sum }_{i = 1}^{m} {α}_{i} {y}_{i} {x}_{i}^{⊤} w + b {\sum }_{i = 1}^{m} {y}_{i} {α}_{i} + \\ {\sum }_{i = 1}^{m} {ξ}_{i} ( C - {α}_{i} ) + {\sum }_{i = 1}^{m} {α}_{i} .\end{matrix} \qquad Equation ( 2 )$$

Note that C is chosen as an arbitrary coefficient such as 1. Also, note that α is a vector of dual variables/multipliers.

In the following problem, an optimal solution must satisfy the constraints of (1) and also αᵢ=0 for every i such that yᵢxᵢ^{T}w−yᵢb+ξᵢ>1:

Minimize_{w,b,ξ}{max_{α}{L(w, b, ξ; α): α≧0}:ξ≧0}}. (3)

It follows that (3) is equivalent to (1). Due to the convexity in terms of (w, b, ξ) and linearity in terms of α, the optimal value of (3) is equal to the optimal value of the following:

Maximize_{α}{min_{w,bξ}{L(w, b, ξ; α):ξ≧0}:α≧0}}. (4)

Let α≧0 be fixed for a moment. If Σᵢ₌₁^{m}yᵢαᵢ≠0, then bΣᵢ₌₁^{m}yᵢαᵢ at is not bounded from below. Similarly, if αᵢ>C, then ξᵢ(C−αᵢ) is not bounded from below when ξᵢ>0. Therefore, an optimal α for (4) must satisfy

Σᵢ₌₁^{m}αᵢyᵢ=0 and αᵢ≦C(i=1, . . . , m).

Next, the unique w that minimizes L(w, b, ζ; α) is

$$w = {\sum }_{i = 1}^{m} {α}_{i} {y}_{i} {x}_{i} . \qquad Equation ( 5 )$$

Finally, if ξ≧0 minimizes L(w, b, ξ; α), then for every i such that αᵢ<C, necessarily ξᵢ=0, and hence

$${\sum }_{i = 1}^{m} {ξ}_{i} ( C - {α}_{i} ) = 0. \qquad Equation ( 6 )$$

Thus, the problem in (4) is equivalent to the following, which can be viewed as the dual problem:

Minimize_{α}½Σᵢⱼyᵢyⱼxᵢ^{T}xⱼαᵢαⱼ−Σᵢαᵢ subject to Σᵢ₌₁^{m}yᵢαᵢ=0 0≦αᵢ≦C (7)

2. SVM on a Join of Two Tables (Executed by the Software Application 160)

2.1 Formulation

We now consider a problem with two tables, T₁ and T₂. The table T₁ has m rows (pⱼ^{T}, uᵢ^{T}), i=1, . . . , m, and the table T₂ has n rows (qⱼ^{T}, vⱼ^{T}),j=1, . . . , n, with columns as follows. (Note that pᵢ^{T} and uᵢ^{T} are attributes of table T₁ and that qⱼ^{T} and vⱼ^{T} are attributes of table T₂.) The attributes that are represented by the columns of these tables are of three types described below. Denote by P the set of attributes represented by the pᵢs, and by Q the set of attributes represented by the qⱼs. The set U of attributes represented by the uᵢS is the same as the set V of attributes represented by the vⱼs (these are the common attributes of the two tables). Note that the s is for plural. The class labels yt are associated with the rows of T₁. The (universal) join of T₁ and T₂ is a new table J, consisting of |P|+|U|+|Q| columns, defined as follows. For each i,i=1, . . . , m, if there is no j such that uⱼ^{T}=vⱼ^{T}, then J has a row xᵢ₀^{T}=(pⱼ^{T}, uⱼ^{T}, 0^{T}); otherwise, J has rows of the form xᵢⱼ^{T}=(pⱼ^{T}, uⱼ^{T}, qⱼ^{T}) for every pair (i,j) such that uⱼ^{T}=vⱼ^{T}. Denote by w_{P}, w_{U} and w_{Q} the projections of the (unknown) vector w on the sets P, U and Q, respectively. Also, denote

I₀={(i, 0):(∀j)(uᵢ≠vⱼ)}

and

IJ=I₀∪{(i,j):uᵢ=vⱼ}.

(Note that I₀ is a set and that IJ is a set) Thus, the explicit form of the primal problem over the join is:

Minimize_{w,b,ξ}½∥w∥²+C·Σ_{(i,j)∈IJ}ξᵢⱼ subject to yᵢxᵢⱼ^{T}w−yᵢb+ξᵢⱼ≧1 ((i,j)∈IJ) ξᵢⱼ≧0 ((i,j)∈IJ) (8)

The size of the latter (i.e., equation (8)) may be too large, depending on the size of the set IJ. Our goal is to solve the SVM problem on J without explicitly generating all the rows of J. We can reformulate this problem by first observing that

xᵢⱼ^{T}w=pᵢ^{T}w_{P}+uᵢ^{T}w_{U}+qⱼ^{T}w_{Q} (9)

where, for convenience, we denote q₀=0.

As a first step, we reduce the number of penalty variables as follows. Instead of using a penalty variable ξᵢⱼ for each (i,j)∈IJ, we generate those penalties in the form

ξᵢⱼ=ηᵢ+ζⱼ (10)

which makes sense in view of (9) because in an optimal solution

ξᵢⱼ=max{0,1−yᵢxᵢ^{T}w+yᵢb}. (11)

Thus, we obtain the following modified optimization problem:

Minimize_{w,b,η,ζ}½∥w∥²+C·Σᵢ₌₁^{m}J(i)·ηᵢ+C·Σⱼ₌₁ⁿI(j)·ζⱼ subject to yᵢxᵢⱼ^{T}w−yᵢb+ηᵢ+ζⱼ≧1 ((i,j)∈IJ) ηᵢ,ζⱼ≧0, (12)

where J(i)=|{j:(i,j)∈IJ}| and I(j)=|{i:(i,j)∈IJ}|. In equation (10), we use the variables ηᵢ and ζⱼ (together which have only m+n number of penalty variables) instead of the ξᵢⱼ (whose number is m·n penalty vairables), i.e., instead of ξᵢⱼ we use ηᵢ+ζⱼ. This reduces the number of penalty variables from m·n (i.e., ξᵢⱼ) to m+n(ηᵢζᵢ).

Note that the number of constraints in problem (12) may still be too large for solving the problem in practice (depending on the size of IJ), so we need to simplify the problem further.

2.2 A Linear-Size Formulation

Denote by z₁, . . . , zₗ all the distinct values that appear as uᵢ. For each k, k=1, . . . , l, denote

Iₖ={i:uᵢ=zₖ}

and

Jₖ={j:vᵢ=zₖ}.

Note that k is the index for the distinct values z. Some sets Jₖ may be empty. Note that the sets I₁, . . . , Iₗ partition the set {1, . . . , m} and also the sets J₁, . . . , Jₗ are pairwise disjoint. We introduce auxiliary variables σ₁, . . . , σₗ and τₖ for k=1, . . . l such that Jₖ≠

Consider the following system of constraints:

yᵢpᵢ^{T}w_{P}−yᵢb+ηᵢ≧σₖ (i∈Iₖ, k=1, . . . l) qⱼ^{T}w_{Q}+ζⱼ≧τₖ (j∈Jₖ, k=1, . . . l) σₖ+zₖ^{T}w_{U}+τₖ≧1 (for k=1, . . . l such that Jₖ≠) σₖ+zₖ^{T}w_{U}≧1 (for k=1, . . . l such that Jₖ=). (13)

The constraints from equation 12 have been broken into four separate constraints as seen in equation (13). Note that auxiliary variables (variables σ₁, . . . , σₗ and τₖ for k=1, . . . l such that Jₖ≠) are new variables that are introduced into the system so that constraining the auxiliary variables together with the original variables in certain ways (as discussed) results in the same set of feasible values for the original variables, yet the size of the algebraic formulation is smaller. The auxiliary variables help solve the problem because the auxiliary variables allow for a reduction in the number of constraints without changing the set of possible feasible solutions.

Proposition 2.1 A Vector w Satisfies the System

yᵢxᵢⱼ^{T}w−yᵢb+ηᵢ+ζⱼ≧1 ((i,j)∈IJ) (14)

if and only if there exist σ₁, . . . , σₗ and τ₁, . . . , τₗ that together with w satisfy the system (13).

Thus, we obtain the following compact form:

Minimize_{w,b,η,ζ,σ,τ}½∥w_{P}∥²+½∥w_{U}∥²½∥w_{Q}∥²+C·Σᵢ₌₁^{m}J(i)·ηᵢ+C·Σⱼ₌₁ⁿI(j)·ζⱼ subject to yᵢpᵢ^{T}w_{P}−yᵢb+ξᵢ−σₖ≧0 (i∈Iₖ, k=1, . . . l) qⱼ^{T}w_{Q}−τₖ≧0 (j∈Jₖ, k=1, . . . l) σₖ+zₖ^{T}w_{U}+τₖ≧1 (for k=1, . . . l such that Jₖ≠) σₖ+zₖ^{T}w_{U}≧1 (for k=1, . . . l such that Jₖ=) ξᵢ≧0 (i=1, . . . , m) (15)

At an optimal solution,

σₖ=min_{i∈I}_{ₖ}{yᵢpᵢ^{T}w_{P}−yᵢb+ηᵢ}

and

τₖ=min_{j∈J}_{ₖ}{qⱼ^{T}w_{Q}ζⱼ}.

(Note that w, b, η, ζ, σ, τ are decision variables of equation (15).) The Lagrangian function of the latter (i.e., equation (15)) is derived as follows. Let αᵢ≧0 be multipliers associated with the constraints:

yᵢpᵢ^{T}w_{P}−yᵢb+ηᵢ−σₖ≧0 (i∈Iₖ, k=1, . . . l) (16)

and recall that the Iₖs are pairwise disjoint. Let β≧0 be multipliers associated with the constraints:

qⱼ^{T}w_{Q}+ζⱼ−τₖ≧0 (j∈Jₖ, k=1, . . . l) (17)

and let γₖ≧0 be multipliers associated with the constraints

σₖ+zₖ^{T}w_{U}+τₖ≧1 (for k=1, . . . l such that Jₖ≠) σₖ+zₖ^{T}w_{U}≧1 (for k=1, . . . l such that Jₖ=). (18)

The Lagrangian function is:

L(w_{P},w_{U},w_{Q},η,ζ,σ,τ;α,β,γ)=½∥w_{P}∥²+½∥w_{U}∥²+½∥w_{Q}∥²+C·Σᵢ₌₁^{m}J(i)ηᵢ+C·Σⱼ₌₁ⁿI(j)ζⱼ−Σₖ₌₁^{l}Σ_{i∈I}_{ₖ}αᵢ(yᵢpᵢ^{T}w_{P}−yᵢb+ηᵢ−σₖ)−Σₖ₌₁^{l}Σ_{j∈J}_{ₖ}βⱼ(qⱼ^{T}w_{Q}+ζⱼ−τₖ)−Σ_{k:J}_{ₖ}_{≠}γₖ(σₖ+zₖ^{T}w_{U}+τₖ−1)−Σ_{k:J}_{ₖ}₌γₖ(σₖ+zₖ^{T}w_{U}−1) (19)

Rearranging terms, we obtain

L(w_{P},w_{U},w_{Q},η,ζ,σ,τ;α,β,γ)=(½∥w_{P}∥²−Σᵢαᵢyᵢpᵢ^{T}w_{P})+(½∥w_{U}∥²−Σₖγₖz_{K}^{T}w_{U})+(½∥w_{Q}∥²−Σⱼβⱼqⱼ^{T}w_{Q})+Σₖ₌₁^{l}γₖ−bΣᵢyᵢαᵢ+Σᵢηᵢ(CJ(i)−αᵢ)+Σⱼζⱼ(CI(j)−βⱼ)+Σₖ₌₁^{l}σₖ(Σ_{i∈I}_{ₖ}αᵢ−γₖ)+Σⱼ_{ₖ}_{≠∈}^{l}τₖ(Σ_{j∈J}_{ₖ}βⱼ−γₖ). (20)

The dual problem is:

Maximize_{α,β,γ}{mix_{w,b,η,ζ,σ,τ}{L(w,b,η,ζ,σ,τ;α,β,γ):ξ≧0}:α,β,γ, ≧0}}. (21)

Let α, β and γ be fixed for the moment. We must have

$$\begin{matrix}{w}_{P} = {\sum }_{i} {α}_{i} {y}_{i} {p}_{i} \\ also , & Equation ( 22 ) \\ {w}_{Q} = {\sum }_{j} {β}_{j} {q}_{j} \\ and & Equation ( 23 ) \\ {w}_{U} = {\sum }_{k} {γ}_{k} {z}_{k} . & Equation ( 24 )\end{matrix}$$

The following are necessary conditions for α, β and γ to be optimal for (21)

Σᵢ₌₁^{m}yᵢαᵢ=0αᵢ≦CJ(i) (i=1, . . . , m) βⱼ≦CI(j) (j=1, . . . , n) γₖ≦αᵢ (k=1, . . . , l, i∈Iₖ) γₖ≦βⱼ (k=1, . . . , l, j∈Jₖ) (25)

If the latter system of equations (i.e., the system (25)) holds, then the optimal values of η, ζ, σ and τ yield the following:

Σᵢηᵢ(CJ(i)−αᵢ)=Σⱼζᵢ(CI(j)−βᵢ)=Σₖ₌₁^{l}σₖ(Σ_{i∈I}_{ₖ}αᵢ−γₖ)=Σ_{J}_{ₖ}_{≠}τₖ(Σ_{j∈j}_{ₖ}βⱼ−γₖ)=0 (26)

It follows that the problem (21) is equivalent to the following dual problem:

Minimize ½Σ_{i,i′}yᵢy_{i′}pᵢ^{T}p_{i′}αᵢα_{i′}+½Σ_{j,j′}qⱼ^{T}q_{j′}βⱼβ_{j′}+½Σ_{k,k′}zₖ^{T}z_{k′}γₖγ_{k′}−Σᵢ₌₁^{m}γᵢ subject to Σᵢ₌₁^{m}yᵢαᵢ=0 0≦αᵢ≦CJ(i) (i=1, . . . , m) 0≦βᵢ≦CI(j) (j=1, . . . , n) 0≦γₖ≦αᵢ (k=1, . . . , l, i∈Iₖ) 0≦γₖ≦βⱼ (k=1, . . . , l, j∈Jₖ) (27)

Note that the size of the latter (i.e., equation (27)) is linear. After the values of w_{P}, w_{Q} and w_{U} have been characterized in equations (22)-(24), their values are used to express |w_{P}∥², ∥w_{Q}∥² and ∥w_{U}∥². This is how we get the first three terms in the objective function of the system in equation (27) because ∥w_{P}∥²=w_{P}^{T}w_{P}, etc. Note that α, β, and γ are multipliers associated with the various constraints as explained above in equations (16)-(18).

Note that (i, i′) are a pair of indexes for y where i′=1, . . . , m, that (i, i′) are a pair of indexes for α where i′=1, . . . , m, and that (i, i′) are a pair of indexes for p where i′=1, . . . , m. Also, note that (j, j′) are a pair of indexes for p where j′=1, . . . , n, and that (j, j′) are a pair of indexes for β where j′=1, . . . , n. Note that (k, k′) are a pair of indexes for z where k′=1, . . . , l, and that (k, k′) are a pair of indexes for γ where k′=1, . . . , l.

3. Extension to Nonlinear Classification (Executed by the Software Application 160)

In the standard formulation of the nonlinear SVM problem, the vectors xᵢ are lifted to a higher-dimensional space [symbol] ^{M} by a nonlinear transformation φ, and the problem is then handled as a linear SVM with examples φ(xᵢ). The dual problem is:

Minimize_{z}½Σᵢⱼyᵢyᵢφ(xᵢ)^{T}φ(xⱼ) αᵢαⱼ−Σᵢαᵢ subject to Σᵢ₌₁^{m}yᵢαᵢ=0 0≦αᵢ≦C. (28)

and the primal solution vector w∈ [symbol] ^{M} must satisfy

$$w = {\sum }_{i = 1}^{m} {α}_{i} {y}_{i} Φ ( {x}_{i} ) . \qquad Equation ( 29 )$$

The products φ(xᵢ^{T}φ(xⱼ) can be generated by kernels K(x, x′):

ψ(xᵢ)^{T}φ(xⱼ)=K(xᵢ, xⱼ). (30)

For example, the so-called quadratic kernel

$$\begin{matrix}K ( x , {x}^{′} ) ≡ {( {x}^{⊤} {x}^{′} + 1 )}^{2} \\ = {( {x}^{⊤} {x}^{′} )}^{2} + 2 {x}^{⊤} {x}^{′} + 1 \\ = {( {\sum }_{i} {x}_{i} {x}_{i}^{′} )}^{2} + 2 {\sum }_{i} {x}_{i} {x}_{i}^{′} + 1 \\ = {\sum }_{i} {{x}_{i}^{2} ( {x}_{i}^{′} )}^{2} + {\sum }_{i \neq j} {x}_{i} {x}_{j} {x}_{i}^{′} {x}_{j}^{′} + 2 {\sum }_{i} {x}_{i} {x}_{i}^{′} + 1\end{matrix}$$

implements the transformation

φ(x)=(1, 2x₁, . . . , 2x_{d}, x₁², . . . , x_{d}², x₁x₂, . . . , x₁, x_{d}, x₂x₁, . . . , x₂x₁, . . . , x₂x_{d}, . . . ) (31)

so that the product φ(xᵢ)^{T}φ(xⱼ) can be calculated without calculating the individual values φ(xᵢ) and φ(xⱼ).

3.1 The Kernel Trick in a Join of Two Tables

In the case of a join of two tables, the examples

xᵢⱼ^{T}=(pᵢ^{T}, uᵢ^{T}, qⱼ^{T})

give rise to the following objective function:

$$\frac{1}{2} {\sum }_{i , {i}^{′}} {y}_{i} {y}_{{i}^{′}} {p}_{i}^{⊤} {p}_{{i}^{′}} {α}_{i} {α}_{{i}^{′}} + \frac{1}{2} {\sum }_{j , {j}^{′}} {q}_{j}^{⊤} {q}_{{j}^{′}} {β}_{j} {β}_{{j}^{′}} + \frac{1}{2} {\sum }_{k , {k}^{′}} {z}_{k}^{⊤} {z}_{{k}^{′}} {γ}_{k} {γ}_{{k}^{′}} - {\sum }_{i = 1}^{m} {γ}_{i} . \qquad Equation ( 32 )$$

It follows that the linear model can be extended into a (separable) nonlinear one as follows. We consider lifting transformations φ that preserve the column structure of the table in the sense that for x=(p, u, q),

φ(xᵢⱼ)^{T}φ(x_{i′j′}) =φ_{P}(pᵢ)^{T}φ_{P}(p_{i′})+φ_{U}(uᵢ)^{T}φ_{U}(u_{i′})+φ_{Q}(qᵢ)^{T}φ_{Q}(q_{i′}).

Thus,

It follows that our problem (27) can be solved in the higher-dimensional space by modifying the objective function into the following:

$$\frac{1}{2} {\sum }_{i , {i}^{′}} {y}_{i} {y}_{{i}^{′}} {Φ }_{p} {( {p}_{i} )}^{⊤} {Φ}_{p} ( {p}_{{i}^{′}} ) {α}_{i} {α}_{{i}^{′}} + \frac{1}{2} {\sum }_{j , {j}^{′}} {{Φ}_{Q} ( {q}_{j} )}^{⊤} {Φ}_{Q} ( {q}_{{j}^{′}} ) {β}_{j} {β}_{{j}^{′}} + \frac{1}{2} {\sum }_{k , {k}^{′}} {{Φ}_{U} ( {z}_{k} )}^{⊤} {Φ}_{U} ( {z}_{{k}^{′}} ) {γ}_{k} {γ}_{{k}^{′}} - {\sum }_{i = 1}^{m} {γ}_{i} . \qquad Equation ( 33 )$$

The “kernel trick” can then be applied if we use transformations that are consistent with conventional kernels, K_{P}(p, p′)=φ_{P}(p)^{T}φ_{P}(p′), K_{U}(u, u′)=φ_{U}(u)^{T}φ_{U}(u′) and K_{Q}(q, q′)=φ_{Q}(q)^{T}φ_{Q}(q′), so the objective can be evaluated in the original space.

4. Joining more than Two Tables (Executed by the Software Application 160)

The ideas of the preceding section can be applied to joins of more than two tables. The size of the formulation depends on the complexity of the database. A simple case is when the tables are T₁, . . . , Tₘ and only pairs (Tᵢ, Tᵢ₊₁) have common columns. Like in the case of joining two tables, we generate the compact formulation by enumerating the distinct values that appear in columns common to two adjacent tables. A similar idea can be applied in a more general setting, e.g., a tree structure, with at most three tables having common columns.

Note that the software application 160 is configured to execute each of the algorithms (including the various equations) discussed herein. Given the algorithms discussed herein, one skilled in the art may utilize a commercial support vector machine optimization software to solve the given algorithms. Also, the software application 160 may include the functions of and/or be integrated with the commercial support vector machine optimization software. The software application 160 may be control and operate the commercial support vector machine optimization software. An example of a commercial support vector machine optimization software that embodiments discussed can be executed in is MATLAB®.

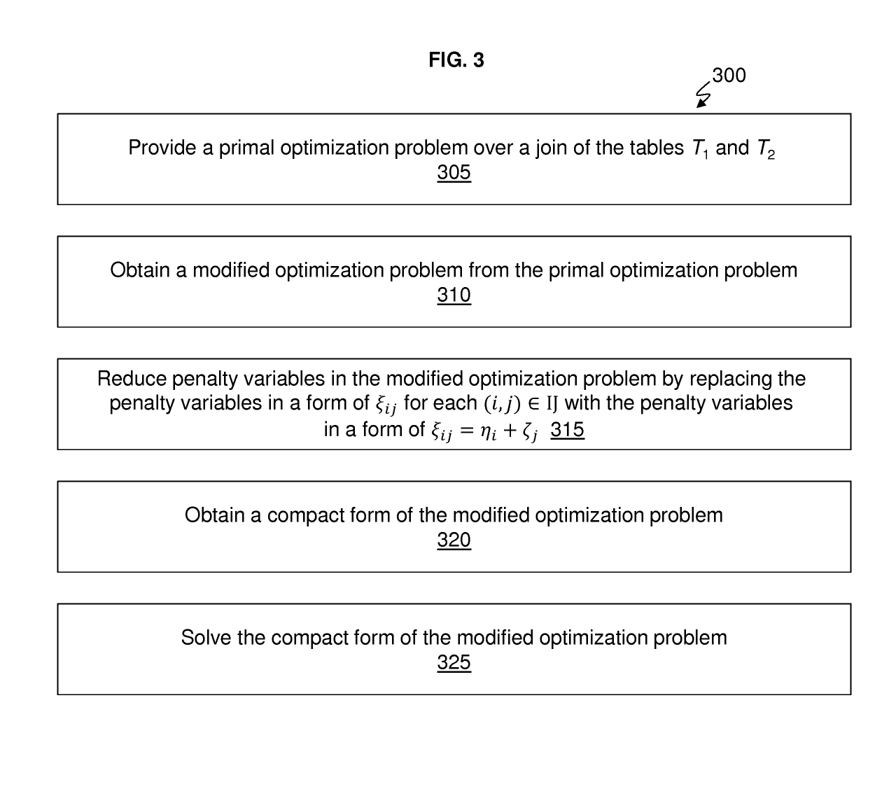

According to an embodiment, FIG. 3 illustrates a method 300, executed by one or more processors 100 on the computer 10, of solving a support vector machine problem on table J defined as the join of two tables T₁ and T₂ without explicitly joining the tables T₁ and T₂, in which the table T₁ has m rows (pᵢ^{T}, uᵢ^{T}), i=1, . . . , m, and the table T₂ has n rows (qⱼ^{T}, vⱼ^{T}), j=1, . . . , n.

At block 305, the computer 100 provides (loads and/or executes) a primal optimization problem over a join of the tables T₁ and T₂, in which the primal optimization problem includes (equation (8)):

minimize_{w,b,ξ}½∥w∥²+C·Σ_{(i,j)∈IJ}ξᵢⱼ subject to yᵢxᵢⱼ^{T}w−yᵢb+ζᵢⱼ≧1 ((i,j)∈IJ) ξᵢⱼ≧0 ((i,j)∈IJ)

At block 310, the computer 100 obtains (loads and/or execute) a modified optimization problem from the primal optimization problem, in which the modified optimization problem includes (equation (12):

Minimize_{w,b,η,ζ}½∥w∥²+C·Σᵢ₌₁^{m}J(i)·ηᵢ+C·Σⱼ₌₁ⁿI(j)·ζⱼ subject to yᵢxᵢⱼ^{T}w−yᵢb+ηᵢ+ζⱼ≧1((i,j)∈IJ) ηᵢ,ζⱼ≧0.

At block 315, the computer 100 reduces penalty variables in the modified optimization problem by replacing the penalty variables in a form of ξᵢⱼ for each (i,j)∈IJ with the penalty variables in a form of ξᵢⱼ=ηᵢζⱼ (as seen in equation (10)).

At block 320, the computer 100 obtains a compact form of the modified optimization problem, in which the compact form (equation (15)) includes:

minimize_{w,b,η,ζ,σ,τ}½∥w_{P}∥²+½∥w_{U}∥²½∥w_{Q}∥²+C·Σᵢ₌₁^{m}J(i)·ηᵢ+C·Σⱼ₌₁ⁿI(j)·ζⱼ subject to yᵢpᵢ^{T}w_{P}−yᵢb+ξᵢ−σₖ≧0 (i∈Iₖ, k=1, . . . l) qⱼ^{T}w_{Q}−τₖ≧0 (j∈Jₖ, k=1, . . . l) σₖ+zₖ^{T}w_{U}+τₖ≧1 (for k=1, . . . l such that Jₖ≠) σₖ+zₖ^{T}w_{U}≧1 (for k=1, . . . l such that Jₖ=) ξᵢ≧0 (i=1, . . . , m)

At block 325, the computer 100 solves the compact form of the modified optimization problem, in which the compact form includes auxiliary variables σ₁, . . . , σ_{ζ} and τₖ for k=1, . . . ζ such that Jₖ≠. One skilled in the art understands that the computer 100 may include and execute commercial software products (such as MATLAB® software) to solve the computations of the compact form (and any other problems/equations discussed herein).

The present invention may be a system, a method, and/or a computer program product: The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, by a computer, of solving a support vector machine problem on table J, defined as the join of two tables T₁ and T₂, without explicitly joining the tables T₁ and T₂, wherein the table T₁ has m rows (pᵢ^{T}, uᵢ^{T}), i=1, . . . , m, and the table T₂ has n rows (qⱼ^{T}, vⱼ^{T}), j=1, . . . , n, the method comprising:
providing a primal optimization problem over a join of the tables T₁ and T₂;
obtaining, by the computer, a modified optimization problem from the primal optimization problem;
reducing penalty variables in the modified optimization problem by replacing the penalty variables in a form of ξᵢⱼ for each (i,j)∈IJ with the penalty variables in a form of ξᵢⱼ=ηᵢ+ζⱼ;
obtaining a compact form of the modified optimization problem in which the compact form comprises the penalty variables in the form of ξᵢⱼηᵢζⱼ; and
solving the compact form of the modified optimization problem.

2. The method of claim 1, wherein the compact form comprises:
Minimize_{w,b,η,ζ,σ,τ}½∥w_{P}∥²+½∥w_{U}∥²½∥w_{Q}∥²+C·Σᵢ₌₁^{m}J(i)·ηᵢ+C·Σⱼ₌₁ⁿI(j)·ζⱼ, subject to yᵢpᵢ^{T}w_{P}−yᵢb+ξᵢ−σₖ≧0 (i∈Iₖ, k=1, . . . l) qⱼ^{T}w_{Q}−τₖ≧0 (j∈Jₖ, k=1, . . . l) σₖ+zₖ^{T}w_{U}+τₖ≧1 (for k=1, . . . l such that Jₖ≠) σₖ+zₖ^{T}w_{U}≧1 (for k=1, . . . l such that Jₖ=) ξᵢ≧0 (i=1, . . . , m);
wherein the compact form includes auxiliary variables σ₁, . . . , σₗ and τₖ for k=1, . . . l such that Jₖ≠.

3. The method of claim 2, wherein the primal optimization problem comprises:
minimize_{w,b,ξ}½∥w∥²+C·Σ_{(i,j)∈IJ}ξᵢⱼ subject to yᵢxᵢⱼ^{T}w−yᵢb+ξᵢⱼ≧1 ((i,j)∈IJ) ξᵢⱼ≧0 ((i,j)∈IJ); and
wherein the modified optimization problem comprises:
minimize_{w,b,η,ζ}½∥w∥²+C·Σᵢ₌₁^{m}J(i)·ηᵢ+C·Σⱼ₌₁ⁿI(j)·ζⱼ subject to yᵢxᵢⱼ^{T}w−yᵢb+ηᵢ+ζⱼ≧1 ((i,j)∈IJ) ηᵢ,ζⱼ≧0.

4. The method of claim 3, further comprising:
denoting a set P as attributes represented by pᵢs;
denoting a set Q as attributes represented by qⱼs;
denoting a set U of attributes represented by uᵢs; and
denoting a set V of attributes represented by vⱼs, wherein the uᵢs and the vⱼs are both common attributes of the T₁ and T₂;
wherein J(i)=|{j:(i,j)∈IJ}|;
wherein I(j)=|{i:(i,j)∈IJ}|;
wherein I₀={(i, 0):(∀j)(uᵢ≠vⱼ)}; and
wherein IJ=I₀∪{(i,j):uᵢ=vⱼ}.

5. The method of claim 4, wherein the table J is a new table based on a universal join of tables T₁ and T₂; and
wherein the table J comprises |P|+|U|+|Q| columns;
wherein class labels yᵢ are associated with the rows of T₁;
wherein denote by z₁, . . . , zₗ all the distinct values that appear as uᵢ, such that for each k, k=1, . . . , l, denote Iₖ={i:uᵢ=zₖ} and Jₖ={j:vᵢ=zₖ};
wherein C is chosen as an arbitrary coefficient; and
wherein b is a scalar.

6. The method of claim 5, wherein for each i, i=1, . . . , m, if there is no j such that uᵢ^{T}=vⱼ^{T}, then J has a row xᵢ₀^{T}=(pᵢ^{T},uᵢ^{T},0^{T}), otherwise, J has rows of the form xᵢⱼ^{T}=(pᵢ^{T}, uᵢ^{T}, qⱼ^{T}) for every pair (i, j) such that uᵢ^{T}=vⱼ^{T}.

7. The method of claim 6, further comprising denoting by w_{P}, w_{U} and w_{Q} projections of an unknown vector w on the sets P, U and Q, respectively.

8. The method of claim 1, further comprising solving the compact form by finding an optimal solution for: σₖ=min_{i∈I}_{ₖ}{yᵢpᵢ^{T}w_{P}−yᵢb+ηᵢ} and τₖmin_{j∈J}_{ₖ}{qⱼ^{T}w_{Q}+ζⱼ}.

9. The method of claim 1, further comprising developing a dual problem from the compact form of the modified optimization problem, the dual problem comprising:
minimize ½Σ_{i,i′}yᵢy_{i′}pᵢ^{T}p_{i′}αᵢα_{i′}+½Σ_{j,j′}qⱼ^{T}q_{j′}βⱼβ_{j′}+½Σ_{k,k′}zₖ^{T}z_{k′}γₖγ_{k′}−Σᵢ₌₁^{m}γᵢ subject to Σᵢ₌₁^{m}yᵢαᵢ=0 0≦αᵢ≦CJ(i) (i=1, . . . , m) 0≦βᵢ≦CI(j) (j=1, . . . , n) 0≦γₖ≦αᵢ (k=1, . . . , l, i∈Iₖ) 0≦γₖ≦βⱼ (k=1, . . . , l, j∈Jₖ).

10. The method of claim 9, further comprising solving the dual problem.

11. A computer program product for solving a support vector machine problem on table J, defined as the join of two tables T₁ and T₂, without explicitly joining the tables T₁ and T₂, wherein the table T₁ has m rows (pᵢ^{T}, uᵢ^{T}), i=1, . . . , m, and the table T₂ has n rows (qⱼ^{T}, vⱼ^{T}), j=1, . . . , n, the computer program product comprising a computer readable storage medium having program instructions embodied therewith, the program instructions executable by computer to cause the computer to perform a method comprising:
providing a primal optimization problem over a join of the tables T₁ and T₂;
obtaining, by the computer, a modified optimization problem from the primal optimization problem;
reducing penalty variables in the modified optimization problem by replacing the penalty variables in a form of ξᵢⱼ for each (i,j)∈IJ with the penalty variables in a form of ξᵢⱼ=ηᵢ+ζⱼ;
obtaining a compact form of the modified optimization problem in which the compact form comprises the penalty variables in the form of ξᵢⱼηᵢζⱼ; and
solving the compact form of the modified optimization problem.

12. The computer program product of claim 11, wherein the compact form comprises:
Minimize_{w,b,η,ζ,σ,τ}½∥w_{P}∥²+½∥w_{U}∥²½∥w_{Q}∥²+C·Σᵢ₌₁^{m}J(i)·ηᵢ+C·Σⱼ₌₁ⁿI(j)·ζⱼ, subject to yᵢpᵢ^{T}w_{P}−yᵢb+ξᵢ−σₖ≧0 (i∈Iₖ, k=1, . . . l) qⱼ^{T}w_{Q}−τₖ≧0 (j∈Jₖ, k=1, . . . l) σₖ+zₖ^{T}w_{U}+τₖ≧1 (for k=1, . . . l such that Jₖ≠) σₖ+zₖ^{T}w_{U}≧1 (for k=1, . . . l such that Jₖ=) ξᵢ≧0 (i=1, . . . , m);
wherein the compact form includes auxiliary variables σ₁, . . . , σₗ and τₖ for k=1, . . . l such that Jₖ≠.

13. The computer program product of claim 12, wherein the primal optimization problem comprises:
minimize_{w,b,ξ}½∥w∥²+C·Σ_{(i,j)∈IJ}ξᵢⱼ subject to yᵢxᵢⱼ^{T}w−yᵢb+ξᵢⱼ≧1 ((i,j)∈IJ) ξᵢⱼ≧0 ((i,j)∈IJ); and
wherein the modified optimization problem comprises:
minimize_{w,b,η,ζ}½∥w∥²+C·Σᵢ₌₁^{m}J(i)·ηᵢ+C·Σⱼ₌₁ⁿI(j)·ζⱼ subject to yᵢxᵢⱼ^{T}w−yᵢb+ηᵢ+ζⱼ≧1 ((i,j)∈IJ) ηᵢ,ζⱼ≧0.

14. The computer program product of claim 13, further comprising:
denoting a set P as attributes represented by pᵢs;
denoting a set Q as attributes represented by qⱼs;
denoting a set U of attributes represented by uᵢs; and
denoting a set V of attributes represented by vⱼs, wherein the uᵢs and the vⱼs are both common attributes of the T₁ and T₂;
wherein J(i)=|{j:(i,j)∈IJ}|;
wherein I(j)=|{i:(i,j)∈IJ}|;
wherein I₀={(i, 0):(∀j)(uᵢ≠vⱼ)}; and
wherein IJ=I₀∪{(i,j):uᵢ=vⱼ}.

15. The computer program product of claim 14, wherein the table J is a new table based on a universal join of tables T₁ and T₂; and
wherein the table J comprises |P|+|U|+|Q| columns;
wherein class labels yᵢ are associated with the rows of T₁;
wherein denote by z₁, . . . , zₗ all the distinct values that appear as uᵢ, such that for each k, k=1, . . . , l, denote Iₖ={i:uᵢ=zₖ} and Jₖ={j:vᵢ=zₖ};
wherein C is chosen as an arbitrary coefficient; and
wherein b is a scalar.

16. The computer program product of claim 15, wherein for each i, i=1, . . . , m, if there is no j such that uᵢ^{T}=vⱼ^{T}, then J has a row xᵢ₀^{T}=(pᵢ^{T},uᵢ^{T},0^{T}), otherwise, J has rows of the form xᵢⱼ^{T}=(pᵢ^{T}, uᵢ^{T}, qⱼ^{T}) for every pair (i, j) such that uᵢ^{T}=vⱼ^{T}.

17. The computer program product of claim 16, further comprising denoting by w_{P}, w_{U} and w_{Q} projections of an unknown vector w on the sets P, U and Q, respectively.

18. The computer program product of claim 11, further comprising solving the compact form by finding an optimal solution for: σₖ=min_{i∈I}_{ₖ}{yᵢpᵢ^{T}w_{P}−yᵢb+η_{i} and τ}ₖ=min_{j∈J}_{ₖ}{qⱼ^{T}w_{Q}+ζⱼ}.

19. The computer program product of claim 11, further comprising developing a dual problem from the compact form of the modified optimization problem, the dual problem comprising:
minimize ½Σ_{i,i′}yᵢy_{i′}pᵢ^{T}p_{i′}αᵢα_{i′}+½Σ_{j,j′}qⱼ^{T}q_{j′}βⱼβ_{j′}+½Σ_{k,k′}zₖ^{T}z_{k′}γₖγ_{k′}−Σᵢ₌₁^{m}γᵢ subject to Σᵢ₌₁^{m}yᵢαᵢ=0 0≦αᵢ≦CJ(i) (i=1, . . . , m) 0≦βᵢ≦CI(j) (j=1, . . . , n) 0≦γₖ≦αᵢ (k=1, . . . , l, i∈Iₖ) 0≦γₖ≦βⱼ (k=1, . . . , l, j∈Jₖ).

20. The computer program product of claim 19, further comprising solving the dual problem.
